(19) United States
(12) Patent Application Publication
(10) Pub. No.: US 2010/0153173 A1
(43) Pub. Date: Jun. 17, 2010

(54) PROVIDING REPORT OF CONTENT MOST SCHEDULED FOR RECORDING

(75) Inventors: Haifeng Bi, San Antonio, TX (US); Xiaolian Bi, San Antonio, TX (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/333,057

(22) Filed: Dec. 11, 2008

(51) Int. Cl. H04H 60/33; G06F 17/30; G06F 7/06; G06Q 50/00; G06Q 10/00

(52) U.S. Cl. 705/10; 725/14; 707/E17.017; 707/E17.044

(57) ABSTRACT

A user is provided a report based on data collected from multimedia content or channels that are most scheduled for recording by users. User defined criteria specify a period used for filtering qualifying recording events for inclusion in the report. The report may be provided on an information channel accessible from a multimedia content distribution network.

### BACKGROUND

1. Field of the Disclosure

The present disclosure generally relates to multimedia content distribution networks and more particularly to providing users access to reports that identify content that is most scheduled for recording by users.

2. Description of the Related Art

Multimedia content may be received over a multimedia content distribution network (MCDN). Users may be unaware of upcoming content that the user may want to view or schedule for recording.

### BRIEF DESCRIPTION OF THE DRAWINGS

FIG. 1 illustrates a representative Internet protocol television (IPTV) architecture for receiving multimedia programs and, in accordance with disclosed embodiments, providing users reports that identify content that is most scheduled for recording by users;

FIG. 2 is a block diagram of selected elements of a multimedia processing resource (MPR), which may be similar to or identical to set-top box (STB) 121 in FIG. 1, and which may be enabled to receive and provide scheduling data to provide users with reports of content that is scheduled for recording; and

FIG. 3 illustrates selected operations of a method for providing users with reports of content that is most scheduled for recording by users.

### DESCRIPTION OF EXEMPLARY EMBODIMENTS

Television programs, video on-demand (VOD) movies, digital television content, music programming, and a variety of other types of multimedia content may be distributed to multiple users (e.g., subscribers) over various types of networks. Suitable types of networks that may be configured to support the provisioning of multimedia content services by a service provider include, as examples, telephony-based networks, coaxial-based networks, satellite-based networks, and the like.

In some networks including, for example, traditional coaxial-based “cable” networks, whether analog or digital, a service provider distributes a mixed signal that includes a large number of multimedia content channels (also referred to herein as “channels”), each occupying a different frequency band or frequency channel, through a coaxial cable, a fiber-optic cable, or a combination of the two. The bandwidth required to transport simultaneously a large number of multimedia channels may challenge the bandwidth capacity of cable-based networks. In these types of networks, a tuner within an STB, television, or other form of receiver is required to select a channel from the mixed signal for playing or recording. A user wishing to play or record multiple channels typically needs to have distinct tuners for each desired channel. This can be an inherent limitation of cable networks and other mixed signal networks.

In contrast to mixed signal networks, IPTV networks generally distribute content to a user only in response to a user request so that, at any given time, the number of content channels being provided to a user is relatively small, e.g., one channel for each operating television plus possibly one or two channels for simultaneous recording. As suggested by the name, IPTV networks typically employ IP and other open, mature, and pervasive networking technologies to distribute multimedia content. Instead of being associated with a particular frequency band, an IPTV television program, movie, or other form of multimedia content is a packet-based stream that corresponds to a particular network endpoint, e.g., an IP address and a transport layer port number. In these networks, the concept of a channel is inherently distinct from the frequency channels native to mixed signal networks. Moreover, whereas a mixed signal network requires a hardware intensive tuner for every channel to be played, IPTV channels can be “tuned” simply by transmitting to a server an indication of a network endpoint that is associated with the desired channel.

IPTV may be implemented, at least in part, over existing infrastructure including, for example, a proprietary network that may include existing telephone lines, possibly in combination with CPE including, for example, a digital subscriber line (DSL) modem in communication with an STB, a display, a program rendering device, and other appropriate equipment to receive multimedia content and convert it into usable form. In some implementations, a core portion of an IPTV network is implemented with fiber optic cables while the so-called “last mile” may include conventional, unshielded, twisted-pair, copper cables.

IPTV networks support bidirectional (i.e., two-way) communication between a subscriber's CPE and a service provider's equipment. Bidirectional communication allows a service provider to deploy advanced features, such as VOD, pay-per-view (PPV), electronic programming guides (EPGs), and the like. Bidirectional networks may also enable a service provider to collect information related to a user's preferences, whether for purposes of providing preference based features to the user, providing potentially valuable information to service providers, or providing potentially lucrative information to content providers and others.

Disclosed embodiments provide reports that inform a user regarding popular multimedia content that is scheduled for recording by users of a multimedia program content provider. Users enter criteria to specify a future period from which to report data regarding scheduled recordings. For example, a user may request a report of multimedia programs that are most scheduled for recording during the next 10 days. A network resource that monitors and records requests to record multimedia content may provide data to a reporting server or customer premises equipment (CPE) device that is used to build the report. The most scheduled recordings may be ranked and provided for display in a report. While reviewing the report, the user may follow the lead of other users and select a multimedia program in the report for recording. Accordingly, disclosed embodiments provide suggestions to a user for upcoming programs he or she may want to view or record. In some embodiments, multimedia programs listed in a report are organized according to genre, appropriateness ratings, or other ratings.

In an exemplary application of a disclosed embodiment, a user requests a report (e.g., a list) of the top ten comedy shows that are scheduled for recording over the next month by users of an MCDN. The report may include selectable icons corresponding to multimedia programs. In response to a user selecting one of the icons, a future recording of the corresponding multimedia program is scheduled. Alternatively, selection of an icon may provide further information regarding the multimedia programs that are in the report.

In one aspect, a disclosed process provides a user with a report of multimedia programs scheduled for recording. A reporting server tracks and records data related to scheduled recordings. A user requests a report and may provide a period for which data is reported. For example, a user may request a report of channels or multimedia programs that are most scheduled for recording in the next ten days. In some embodiments, users are initially provided a report based on default report parameters, and users may request further information. For example, a reporting server may respond to a user request with a report of the most scheduled recordings for a default period of the upcoming week. The user may then request a different report of the most scheduled recordings for a range of dates or another future period.

Disclosed systems may permit a user to specify parameters for including programs or channels scheduled for recording in the report. For example, a user may specify a report with the top twenty channels or programs scheduled for recording in a future period (e.g., next month). In such cases, disclosed processes select multimedia programs or channels for inclusion in the report based on whether a minimum level of popularity (e.g., top twenty) is achieved by the multimedia program or channel. User parameters for reports may be entered by remote control communicatively coupled to an STB or by a Web portal, as examples. Reports of the most scheduled multimedia programs or channels may be received on a program rendering device (e.g., a television) or on a PC that receives data from a Web portal. Reports of the most scheduled multimedia programs or channels may also be provided in response to a user selecting to view an information channel (e.g., channel 92 as provided by a multimedia content provider). In some embodiments, the report is organized according to the genres or appropriateness ratings.

In another aspect, a disclosed service provides users with reports of scheduled multimedia recording events. The service includes ranking a multimedia program according to a number of user requests to record the program. A reporting server, for example, may track all recording requests of users of a multimedia content provider. The reporting server may store and continuously update ranking data for recorded multimedia programs and channels and filter the data to provide reports with relevant data for a given period (e.g., the next week, the next month, the next two months). Additional user criteria (e.g., genre) may be received and used to organize and format reports. A reporting server may maintain a repertoire of default reports, of reports that are commonly requested, and of reports that are expected to be requested often. For example, a reporting server may continuously maintain and update a report for common genres such as athletic events, situational comedies, and cartoons most scheduled for recording in the next week. In this way, reporting servers may readily respond to expected requests for reports.

In some disclosed embodiments, reporting servers keep running totals of all or substantially all programs and/or channels scheduled for recording. The reporting server may then filter the collected data in response to a user specifying a future period for requested data. The raw data or filtered data may be downloaded to a CPE device (e.g., a customer STB or PC) in response to a user request for a report. The downloaded data may be filtered according a requested future period (e.g., next week) and according to additional user criteria (e.g., most cartoons scheduled for recording). Accordingly, provided reports include data for a future period (e.g., the next ten days) for multimedia programs or channels most scheduled for recording and may be further organized according to user criteria.

In still another aspect, a disclosed reporting server stores recording request data and provides to users filtered recording request data for a future period. The filtered recording request data is provided in a report that may be accessed on a Web portal, provided on a user television, or provided on a user PC, as examples. Reports may be organized in a default configuration or according to user provided criteria. For example, reports may exclude data pertaining to requests to record multimedia programs airing before or after a defined future period. In some embodiments, a user defines the future period. Also, a user may be presented with a plurality of predetermined future periods (e.g., one week, one month, etc.) from which to choose. A user's CPE may contribute recording request data by monitoring a plurality of local user requests to record multimedia programs and sending the resulting data to a network based reporting server.

Below, exemplary embodiments are described with sufficient detail to enable one of ordinary skill in the art to practice the disclosed subject matter without undue experimentation. It should be apparent to a person of ordinary skill that the disclosed examples are not exhaustive of all possible embodiments. Regarding reference numerals used to describe elements in the figures, a hyphenated form of a reference numeral typically refers to a specific instance of an element and an un-hyphenated form of the reference numeral refers to the element generically or collectively. Thus, for example, element 121-1 refers to an instance of an STB, which may be referred to collectively as STBs 121 and any one of which may be referred to generically as an STB 121.

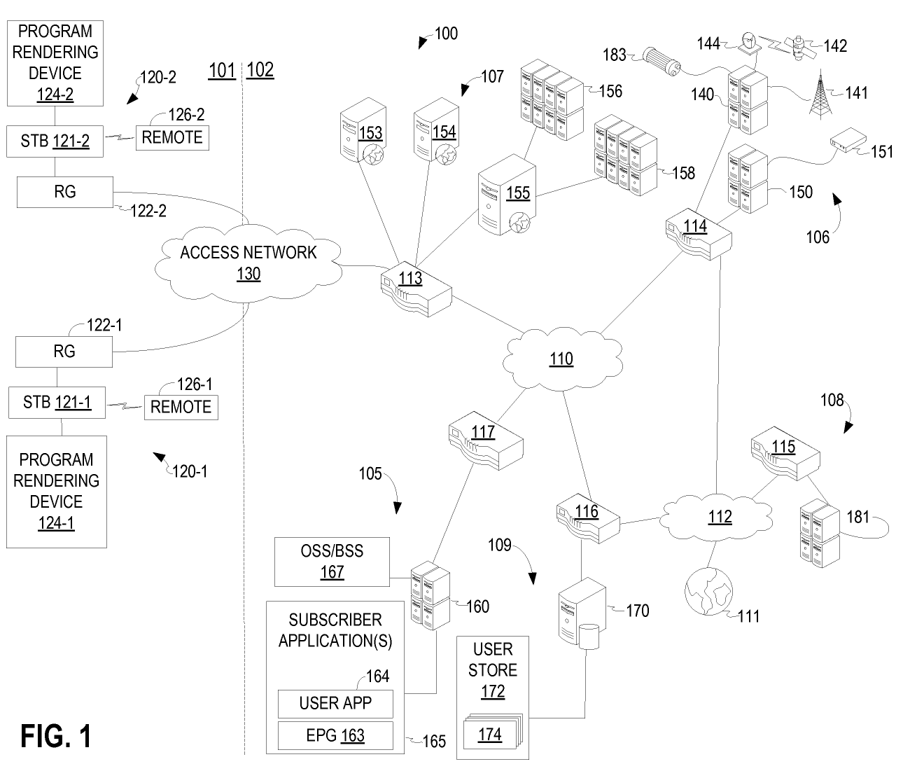

Referring now to the drawings, FIG. 1 illustrates selected aspects of a multimedia content distribution network (MCDN) 100 for monitoring and reporting regarding content that is most scheduled for recording by users of MCDN 100. MCDN 100, as shown, is a multimedia content provider network that may be generally divided into a client side 101 and a service provider side 102 (a.k.a., server side 102). Client side 101 includes all or most of the resources depicted to the left of access network 130 while server side 102 encompasses the remainder.

Client side 101 and server side 102 are linked by access network 130. In embodiments of MCDN 100 that leverage telephony hardware and infrastructure, access network 130 may include the “local loop” or “last mile,” which refers to the physical cables that connect a subscriber's home or business to a local exchange. In these embodiments, the physical layer of access network 130 may include both twisted pair copper cables and fiber optics cables. In a fiber to the curb (FTTC) access network, the “last mile” portion that employs copper is generally less than approximately 300 feet in length. In fiber to the home (FTTH) access networks, fiber optic cables extend all the way to the premises of the subscriber.

Access network 130 may include hardware and firmware to perform signal translation when access network 130 includes multiple types of physical media. For example, an access network that includes twisted-pair telephone lines to deliver multimedia content to consumers may utilize DSL. In embodiments of access network 130 that implement FTTC, a DSL access multiplexer (DSLAM) may be used within access network 130 to transfer signals containing multimedia content from optical fiber to copper wire for DSL delivery to consumers.

Access network 130 may transmit radio frequency (RF) signals over coaxial cables. In these embodiments, access network 130 may utilize quadrature amplitude modulation (QAM) equipment for downstream traffic. Also in these embodiments, access network 130 may receive upstream traffic from a consumer's location using quadrature phase shift keying (QPSK) modulated RF signals.

Services provided by the server side resources as shown in FIG. 1 may be distributed over a private network 110. In some embodiments, private network 110 is referred to as a “core network.” In at least some embodiments, private network 110 includes a fiber optic wide area network (WAN), referred to herein as the fiber backbone, and one or more video hub offices (VHOs). In large-scale implementations of MCDN 100, which may cover a geographic region comparable, for example, to the region served by telephony-based broadband services, private network 110 includes a hierarchy of VHOs.

A national VHO, for example, may deliver national content feeds to several regional VHOs, each of which may include its own acquisition resources to acquire local content, such as the local affiliate of a national network, and to inject local content such as advertising and public service announcements (e.g., emergency alert system messages) from local entities. The regional VHOs may then deliver the local and national content to users served by the regional VHO. The hierarchical arrangement of VHOs, in addition to facilitating localized or regionalized content provisioning, may conserve bandwidth by limiting the content that is transmitted over the core network and injecting regional content “downstream” from the core network.

Segments of private network 110, as shown in FIG. 1, are connected together with a plurality of network switching and routing devices referred to simply as switches 113 through 117. The depicted switches include client facing switch 113, acquisition switch 114, operations-systems-support/business-systems-support (OSS/BSS) switch 115, database switch 116, and an application switch 117. In addition to providing routing/switching functionality, switches 113 through 117 preferably include hardware or firmware firewalls, not depicted, that maintain the security and privacy of network 110. Other portions of MCDN 100 may communicate over a public network 112, including, for example, an Internet or other type of Web network which is signified in FIG. 1 by the World Wide Web icon 111.

As shown in FIG. 1, client side 101 of MCDN 100 depicts two of a potentially large number of client side resources referred to herein simply as client(s) 120. Each client 120, as shown, includes an STB 121, a residential gateway (RG) 122, a program rendering device 124, and a remote control device 126. In the depicted embodiment, STB 121 communicates with server side 102 devices through access network 130 via RG 122.

As shown in FIG. 1, RG 122 may include elements of a broadband modem (e.g., DSL modem or cable modem) and may communicate over wireless and/or wired interfaces. In addition, RG 122 may have elements of a firewall, router, switch, and access point for local area network (LAN) devices to communicate through wired and wireless (e.g., WiFi) Ethernet or other suitable networking technologies. In some embodiments, STB 121 is a uniquely addressable Ethernet compliant device. Program rendering device 124 may be, for example, any National Television System Committee (NTSC) and/or Phase Alternating Line (PAL) compliant program rendering device. Both STB 121 and program rendering device 124 may include any form of conventional frequency tuner.

In IPTV compliant implementations of MCDN 100, clients 120 are configured to receive packet-based multimedia streams from access network 130 and process the streams for presentation on program rendering devices 124. In addition, clients 120 are network-aware resources that may facilitate bidirectional-networked communications with server side 102 resources to support network hosted services and features. Because clients 120 are configured to process multimedia content streams while simultaneously supporting more traditional Web-like communications, clients 120 may support or comply with a variety of different types of network protocols including streaming protocols such as real-time transport protocol (RTP) over user datagram protocol/Internet protocol (UDP/IP), as well as web protocols such as hypertext transport protocol (HTTP) over transport control protocol (TCP/IP).

The server side 102 of MCDN 100, as depicted in FIG. 1, emphasizes network capabilities including application resources 105, which may have access to database resources 109, content acquisition resources 106, content delivery resources 107, and OSS/BSS resources 108.

Before distributing multimedia content to users, MCDN 100 first obtains multimedia content from content providers. To that end, acquisition resources 106 encompass various systems and devices to acquire multimedia content, reformat it when necessary, and process it for delivery to subscribers over private network 110 and access network 130.

Acquisition resources 106 may include, for example, systems for capturing analog and/or digital content feeds, either directly from a content provider or from a content aggregation facility. Content feeds transmitted via VHF/UHF broadcast signals may be captured by an antenna 141 and delivered to live acquisition server 140. Similarly, live acquisition server 140 may capture down-linked signals transmitted by a satellite 142 and received by a parabolic dish 144. In addition, live acquisition server 140 may acquire programming feeds transmitted via high-speed fiber feed 183 or other suitable transmission means. Acquisition resources 106 may further include signal conditioning systems and content preparation systems for encoding content.

As depicted in FIG. 1, content acquisition resources 106 include a VOD acquisition server 150. VOD acquisition server 150 receives content from one or more VOD sources that may be external to the MCDN 100 including, as examples, discs represented by a DVD player 151, or transmitted feeds (not shown). VOD acquisition server 150 may temporarily store multimedia content for transmission to a VOD delivery server 158 in communication with client-facing switch 113.

After acquiring multimedia content, acquisition resources 106 may transmit acquired content over private network 110, for example, to one or more servers in content delivery resources 107. Live acquisition server 140 is communicatively coupled to an encoder which, prior to transmission, encodes acquired content using for example, Motion Picture Expert Group (MPEG) standards such as MPEG-2, MPEG-4, a Windows Media Video (WMV) family codec, or another suitable video codec.

Content delivery resources 107, as shown in FIG. 1, are in communication with private network 110 via client facing switch 113. In the depicted implementation, content delivery resources 107 include a content delivery server 155 in communication with a live or real-time content server 156 and a VOD delivery server 158. For purposes of this disclosure, the use of the term “live” or “real-time” in connection with content server 156 is intended primarily to distinguish the applicable content from the content provided by VOD delivery server 158. The content provided by a VOD server is sometimes referred to as time-shifted content to emphasize the ability to obtain and view VOD content substantially without regard to the time of day or the day of week.

Content delivery server 155, in conjunction with live content server 156 and VOD delivery server 158, responds to user requests for content by providing the requested content to the user. The content delivery resources 107 are, in some embodiments, responsible for creating video streams that are suitable for transmission over private network 110 and/or access network 130. In some embodiments, creating video streams from the stored content generally includes generating data packets by encapsulating relatively small segments of the stored content according to the network communication protocol stack in use. These data packets are then transmitted across a network to a receiver (e.g., STB 121 of client 120), where the content is parsed from individual packets and re-assembled into multimedia content suitable for processing by a decoder.

User requests received by content delivery server 155 may include an indication of the content that is being requested. In some embodiments, this indication includes a network endpoint associated with the desired content. The network endpoint may include an IP address and a transport layer port number. For example, a particular local broadcast television station may be associated with a particular channel and the feed for that channel may be associated with a particular IP address and transport layer port number. When a user wishes to view the station, the user may interact with remote control device 126 to send a signal to STB 121 indicating a request for the particular channel. When STB 121 responds to the remote control signal, the STB 121 changes to the requested channel by transmitting a request that includes an indication of the network endpoint associated with the desired channel to content delivery server 155.

Content delivery server 155 may respond to such requests by making a streaming video or audio signal accessible to the user. Content delivery server 155 may employ a multicast protocol to deliver a single originating stream to multiple clients. When a new user requests the content associated with a multicast stream, there may be latency associated with updating the multicast information to reflect the new user as a part of the multicast group. To avoid exposing this undesirable latency to a user, content delivery server 155 may temporarily unicast a stream to the requesting user. When the user is ultimately enrolled in the multicast group, the unicast stream is terminated and the user receives the multicast stream. Multicasting desirably reduces bandwidth consumption by reducing the number of streams that must be transmitted over the access network 130 to clients 120.

As illustrated in FIG. 1, a client-facing switch 113 provides a conduit between client side 101, including client 120, and server side 102. Client-facing switch 113, as shown, is so-named because it connects directly to the client 120 via access network 130 and it provides the network connectivity of IPTV services to users' locations. To deliver multimedia content, client-facing switch 113 may employ any of various existing or future Internet protocols for providing reliable real-time streaming multimedia content. In addition to the TCP, UDP, and HTTP protocols referenced above, such protocols may use, in various combinations, other protocols including RTP, real-time control protocol (RTCP), file transfer protocol (FTP), and real-time streaming protocol (RTSP).

In some embodiments, client-facing switch 113 routes multimedia content encapsulated into IP packets over access network 130. For example, an MPEG-2 transport stream may be sent in which the transport stream consists of a series of 188-byte transport packets. In some embodiments, the MPEG-2 transport stream may include reports of content most scheduled for recording for presentation on a user's program rendering device. Client-facing switch 113, as shown, is coupled to a content delivery server 155, acquisition switch 114, applications switch 117, a client gateway 153, and a terminal server 154 that is operable to provide terminal devices with a connection point to the private network 110. Client gateway 153 may provide subscriber access to private network 110 and the resources coupled thereto.

In some embodiments, STB 121 may access MCDN 100 using information received from client gateway 153. Subscriber devices may access client gateway 153, and client gateway 153 may then allow such devices to access private network 110 once the devices are authenticated or verified. Similarly, client gateway 153 may prevent unauthorized devices, such as hacker computers or stolen STBs, from accessing the private network 110. Accordingly, in some embodiments, when an STB 121 accesses MCDN 100, client gateway 153 verifies subscriber information by communicating with user store 172 via the private network 110. Client gateway 153 may verify billing information and subscriber status by communicating with an OSS/BSS gateway 167, which may translate a query to the OSS/BSS server 181. Upon client gateway 153 confirming subscriber and/or billing information, client gateway 153 may allow STB 121 access to IPTV content, VOD content, and other services. If client gateway 153 cannot verify subscriber information (i.e., user information) for STB 121, for example, because it is connected to an unauthorized local loop or RG, client gateway 153 may block transmissions to and from STB 121 beyond access network 130.

MCDN 100, as depicted, includes application resources 105, which communicate with private network 110 via application switch 117. Application resources 105, as shown, include application server 160 which is operable to host or otherwise facilitate one or more subscriber applications 165 that are made available to system subscribers. For example, subscriber applications 165, as shown, include EPG application 163. Subscriber applications 165 may include other applications as well. In addition to subscriber applications 165, application server 160 may host or provide a gateway to operation support systems and/or business support systems. In some embodiments, communication between application server 160 and the applications that it hosts and/or communication between application server 160 and client 120 may be via a conventional web based protocol stack such as HTTP over TCP/IP or HTTP over UDP/IP.

Application server 160 as shown also hosts an application referred to generically as user application 164. User application 164 represents an application that may deliver a value added feature to a user, who may be a subscriber to a service provided by MCDN 100. For example, in accordance with disclosed embodiments, user application 164 may be an application that monitors recording requests by users of MCDN 100, applies administrator or user configured rules and parameters (e.g., inclusion criteria, specified future period, etc.) and provides a report informing a user or users of multimedia content (or channels) that are popular according to the number of viewers that have requested to record the multimedia content (or channels). User application 164, as illustrated in FIG. 1, emphasizes the ability to extend the network's capabilities by implementing a network-hosted application. Because user application 164 may reside on the network, it generally does not impose any significant requirements or imply any substantial modifications to client 120 including STB 121. In some instances, an STB 121 may require knowledge of a network address associated with user application 164, but STB 121 and the other components of client 120 are largely unaffected.

As shown in FIG. 1, a database switch 116, as connected to applications switch 117, provides access to database resources 109. Database resources 109 include database server 170 that manages a system storage resource 172, also referred to herein as user store 172. User store 172, as shown, includes one or more user profiles 174 where each user profile includes account information and may include preferences information that may be retrieved by applications executing on application server 160 including user applications 165.

As shown, MCDN 100 is enabled to provide a service that provides users with reports of scheduled multimedia recording events. The service may be carried out in part by reporting server 189 which receives and compiles information regarding multimedia programs and channels that are scheduled for recording by users of MCDN 100. The disclosed service includes ranking a multimedia program according to a quantity of users that request to record a multimedia program, storing data indicative of the ranking, and repeating the ranking and storing for a plurality of multimedia programs. A user (e.g., a user of client 120-2) may provide input that defines criteria for including channels or multimedia programs in the report. Reports may contain ranking data, ranked multimedia programs, indications (e.g., icons) of ranked multimedia programs, and indications of channels. In an exemplary application of a disclosed service, a user of client 120-2 provides input using remote control device 126-2 that specifies a future period during which scheduled programming will air. Example future periods include one week, one day, one month, or the like. In some embodiments, a user is presented with predetermined selectable future periods. For example, a user of client 120-2 may be presented a graphical interface on program rendering device 124-2 that has a list of selectable icons that represent future periods and that include one week, one day, and one month. User input may also include, without limitation, a genre (e.g., comedy), an appropriateness rating (e.g., restricted due to the language), or popularity data (e.g., three stars out of five stars).

The disclosed service includes reporting server 189 accessing the ranking data and determining multimedia recording events that qualify for the report based on the criteria received from the user input. If a user of client 120-2 requests the report, reporting server 189 is enabled for causing transport of the report over access network 130 to client 120-2 for viewing on program rendering device 124-2. Reports may also be available for access by a Web portal, for example. The displayed report includes qualifying multimedia recording events that meet user specified criteria. The report may present qualifying multimedia recording events according to genre, popularity ratings, or the like. MCDN 100 may provide an information channel on which to access the report. For example, if channel 100 is the information channel, users select channel 100 to view the report.

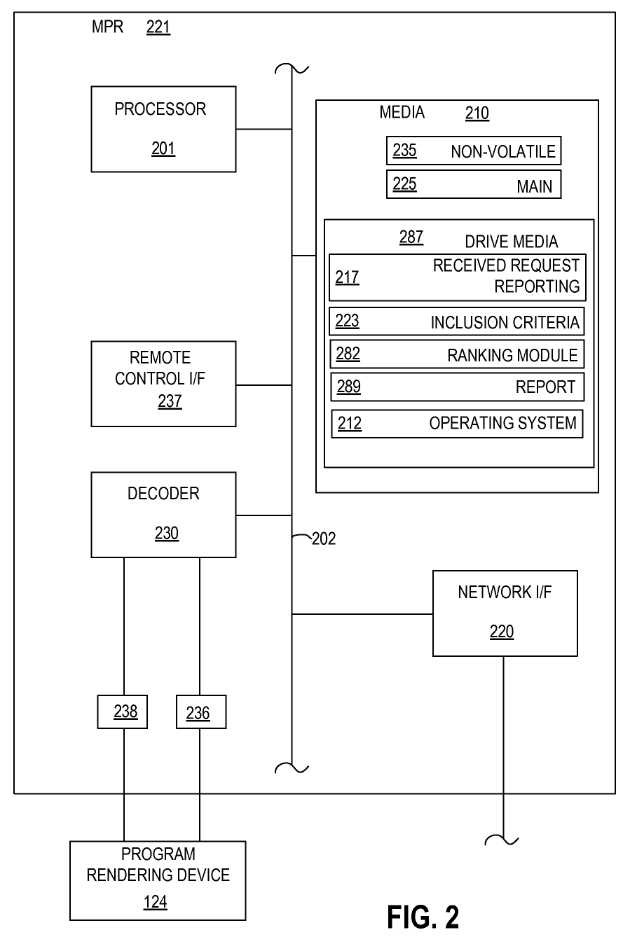

Referring to FIG. 2, a block diagram illustrating selected elements of MPR 221 is presented. MPR 221 may be identical to or similar to STB 121 (FIG. 1) and enables users to receive multimedia content. MPR 221 supports recording features, and recorded programs may be stored to drive media 287 or other storage. In the depicted embodiment, MPR 221 includes a processor 201 communicatively coupled to media 210 via a shared bus 102. Media 210 may include main memory 225 and non-volatile memory 235. Media 210 is operable to store instructions, data, or both. Media 210 as shown includes multiple sets or sequences of instructions, namely, operating system 212, received request reporting module 217, inclusion criteria 223, ranking module 282, and report 289. Operation system 212 may be a Unix® or Unix-like operating system, a Windows® family operating system, or another suitable operating system.

MPR 221 as depicted in FIG. 2 further includes a network adapter 220 that interfaces MPR 221 to access network 130 (FIG. 1), possibly through a residential gateway (e.g., RG 122 in FIG. 1). MPR 221 may be similar to or identical to STB 121 and receive multimedia content such as television content from access network 130 (FIG. 1). In embodiments suitable for use in IP based content delivery networks, MPR 221, as depicted in FIG. 2, may include an audio/video (A/V) decoder 230 that assembles payloads from a sequence or set of network packets into a stream of multimedia content. The stream of multimedia content may include audio information and video information and A/V decoder 230 may parse or segregate the two to generate a video stream 238 and an audio stream 236 as shown. Reports of qualifying multimedia recording events may be included with video stream 238 for presentation on program rendering device 124.

Video and audio streams 238 and 236 may include audio or video information that is compressed, encrypted, or both. Video stream 238 may include information formatted using any video decoding algorithm including for example without limitation any of the MPEG standards or WMV standards. Similarly, audio stream 236 may include information formatted using any audio decoding algorithm including for example without limitation: Dolby® Digital, Digital Theatre System (DTS) Coherent Acoustics, and Windows Media Audio (WMA). The video and audio streams 238 and 236, as shown in FIG. 1, are sent in a format compliant with program rendering device 124, which itself may not be a part of MPR 221. Program rendering device 124 may comply with NTSC, PAL or any other suitable television standard.

As shown, MPR 221 may be enabled to perform an embodied process for providing to a user a report of multimedia programs scheduled for recording. Accordingly, processor 201 executes instructions stored on drive media 287 including ranking module 282 which selects a multimedia program for inclusion in report 289 based on whether the multimedia program has at least a minimum level of popularity and based on whether the multimedia program airs during a predetermined future period. Inclusion criteria 223 includes stored data for the predetermined future period (e.g., one week, one day, ten days, etc.) which may be received by a user over remote control interface 237 or network interface 220. Inclusion criteria module 223 includes instructions for selecting a multimedia program for inclusion in the report based on whether the multimedia program has a requested genre, level of popularity (e.g., a rating of three stars out of five), or appropriateness rating (e.g., adult content, suitable for all audiences, or some other such designation).

Responsive to a user selection to receive the report, MPR 221 produces the report with video stream 238 and/or audio stream 236 for receipt on program rendering device 124. The report may include video portions, audio portions, or both. The user may provide input to receive the report by using a remote control device (e.g., remote control device 126 in FIG. 1) to select an information channel (e.g., channel 100) provided by an MCDN (e.g., MCDN 100 and FIG. 1). A user may define the future period and other criteria by entering textual information (e.g., numbers) through a remote control device that communicates with MPR 221 over remote control interface 237 or network interface 220. A user may also receive the report and define report criteria on a Web portal, for example. In some embodiments, a user is provided (e.g., on program rendering device 124) predetermined future periods that are selectable by the user. For example, a user may be presented with a list of predetermined periods including one day, two days, one week, ten days, or one month, and the user may select an item from the list that defines the future period accordingly. A report may be presented in a default configuration in response to a user request to view the report. For example, a user may request the most popular channel that is scheduled for recording and disclosed embodiments may, by default, present the most popular channels scheduled for recording in the next week. If the user wishes to define a different period than the coming week, the user may do so in some embodiments.

As discussed herein, the user may specify the future period during which the channels “air” the content subject to recording. In the context of this disclosure, the term “air” is not intended to require that a multimedia program is transmitted by or through air using radio waves. Indeed, the term is meant to include other methods, protocols, or media for transmitting, broadcasting, simulcasting, unicasting, providing for download, or otherwise providing access to multimedia programs including transmission over fiber-optic cables, coaxial cables, digital subscriber lines, WiFi networks, and the like. In some embodiments, a user may already have possession of a tangible medium on which a multimedia program is stored, and the term “air” may include that the user is granted access to the multimedia program. In the context of this disclosure, the term “future period” is intended primarily to describe a period of time during which scheduled recordings by users will occur.

As discussed, MPR 221 decodes for program rendering device 124 multimedia content received from an MCDN (e.g., MCDN 100 in FIG. 1). In response to a user request to view the report, MPR 221 produces the report with video stream 238 and/or audio stream 236 for presentation by program rendering device 124. The displayed report may include indications (e.g., text, icons, video clips, screen shots, photographs, synthesized voice output, metadata, and avatars) of qualifying scheduled recordings that are organized according to user supplied criteria. In some embodiments, the displayed report includes indications of the channel on which the multimedia programming scheduled for recording is received.

In some embodiments, a user of MPR 221 schedules recordings of multimedia programs and data related to the scheduled recordings is reported to a reporting server by received request reporting module 217. Recording request data may be received by the reporting server from all or substantially all users of an MCDN. The reporting server may collect and update the recording request data in real time as recording requests are made. A user may define a predetermined period for which the user wishes to receive a report of the programs or channels most scheduled for recording. In such cases, the reporting server filters data before sending the report data to MPR 221. In other cases, raw data is sent from the reporting server to MPR 221 which then filters the data and presents it in a report according to user specified criteria. Accordingly, as shown in FIG. 2, ranking module 282 filters recording request data and excludes data pertaining to requests to record multimedia programs airing before or after a defined future period stored in inclusion criteria 223. Responsive to a user input, decoder 230 provides a representation of report 289 on program rendering device 124. Report 289 is populated based on the filtered future request data, which includes the recording request data filtered to include multimedia programs or channels (or indications of the same) that are scheduled for recording during the specified future period.

In some embodiments, MPR 221 may respond to requests from remote network elements that provide data related to channels or multimedia programs scheduled for recording by MPR 221. For example, reporting server 189 (FIG. 1) may request scheduled recording data from MPR 221 through MCDN 100. In such cases, received request reporting module 217 is enabled to transmit over network interface 220 data that is received over time by monitoring local user requests to record multimedia programs or channels. The monitored data is transmitted over network interface 220. For example, in the embodiment illustrated in FIG. 1, STB 121-2 (i.e., an MPR) may transmit to reporting server 189 data that is related to scheduled recordings local to STB 121-2.

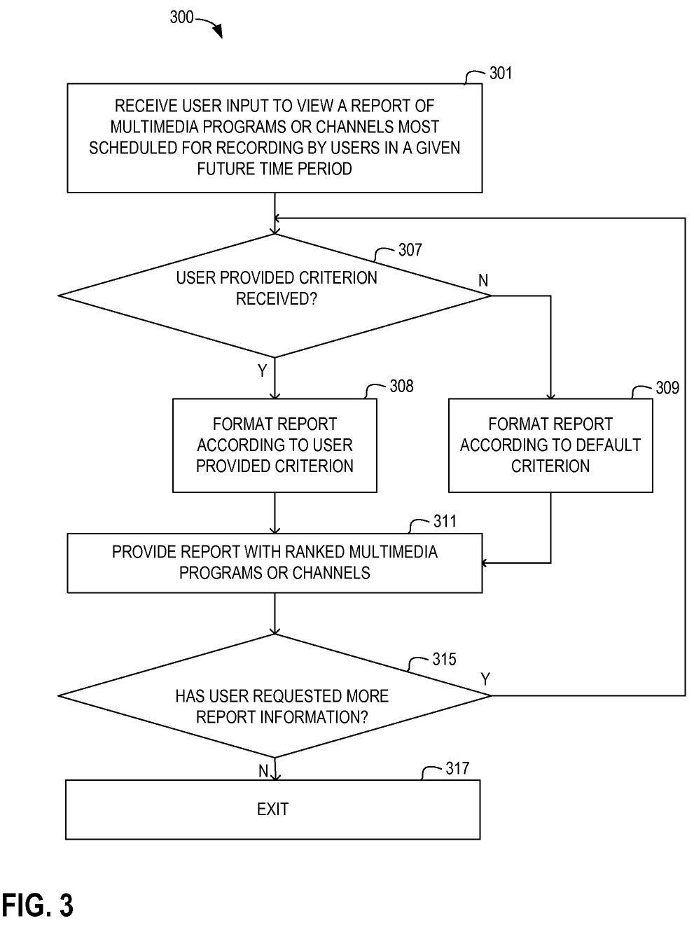

As shown, FIG. 3 illustrates a method 300 for providing a user with a report of popular content that is scheduled for recording by users. Method 300 includes receiving (block 301) user input to view a report of multimedia programs or channels most scheduled for recording by users in a given future period. User input may be entered using a remote control device (e.g., remote control device 126 in FIG. 1) communicatively coupled to an STB (e.g., STB 121 in FIG. 1). Method 300 further includes determining (block 307) whether user provide criterion has been received regarding formatting and organizing the report. If so, a report is formatted (block 308) according to the user provided criterion. For example, a user may provide criteria that specify a report of the twenty most scheduled channels for the next five days that show sports. If no user provided criterion is provided, the requested report is formatted (block 309) according to default criterion. For example, the report may show the top ten most channels scheduled for recording for the next week. Whether using default criteria, user provided criteria, or both, a report with ranked multimedia programs or channels is provided (block 315) to the user. The report may be provided on a Web portal, on an information channel, or using any medium or device accessible by the user. If the user requests more information, method 300 returns to provide further reports according to user provided and/or default criteria. If no further report information is requested by the user, method 300 exits (block 317).

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A process for providing to a user a report of multimedia programs scheduled for recording, the process comprising:
monitoring a quantity of record requests to determine relative popularity levels for a plurality of multimedia programs provided by a multimedia content distribution network;
selecting an individual multimedia program from the plurality of multimedia programs for inclusion in the report based at least in part on:
whether a popularity of the multimedia program exceeds a minimum level; and
whether the multimedia program airs during a future period; and
providing the report for display.

2. The process of claim 1,
wherein said selecting of the multimedia program for inclusion in the report is further based on:
whether the multimedia program has a requested genre.

3. The process of claim 1, further comprising:
providing a selectable channel for viewing the report.

4. The process of claim 1, further comprising:
receiving a user criterion for formatting the report.

5. The process of claim 1, wherein said receiving includes receiving the user criterion on via a Web portal.

6. The process of claim 1, wherein said monitoring includes receiving a plurality of record requests from set-top boxes.

7. The process of claim 1, further comprising:
receiving user input defining the minimum level of popularity.

8. The process of claim 7, wherein a multimedia program exceeds the minimum level of popularity when the multimedia program is ranked within a number X of a most popular multimedia program scheduled for recording.

9. The process of claim 1, further comprising:
receiving user input defining the future period.

10. The process of claim 9, wherein the future period is one of one week and one day.

11. A service for providing a report of scheduled multimedia recording events, the service comprising:
ranking a multimedia program according to a quantity of user requests to record the multimedia program;
storing data indicative of the ranking;
repeating said ranking and said storing for a plurality of multimedia programs;
receiving user input defining criteria for including at least one of the ranking data and the ranked multimedia programs in the report;
accessing the ranking data to determine qualifying multimedia recording events based on the criteria; and
providing the report for display, wherein the report includes the qualifying multimedia recording events.

12. The service of claim 11, further comprising:
presenting the qualifying multimedia recording events in the report according to genres of corresponding multimedia programs.

13. The service of claim 11, further comprising:
presenting the qualifying multimedia recording events in the report according to popularity ratings of corresponding multimedia programs.

14. The service of claim 11, further comprising:
presenting the qualifying multimedia recording events in the report according to appropriateness ratings of corresponding multimedia programs.

15. The service of claim 11, further comprising:
providing a channel on which to access the report.

16. The service of claim 11, wherein the criteria further define a future period.

17. The service of claim 16, wherein the future period is one of one week and one day.

18. The service of claim 16, further comprising
providing a selectable predetermined future period.

19. A reporting server communicatively coupled to at least one tangible computer readable medium that includes instructions for:
receiving recording request data;
filtering the recording request data to exclude data pertaining to requests to record multimedia programs airing before or after a defined future period; and
responsive to user input, providing a report based on the filtered recording request data.

20. The reporting server of claim 19, further including instructions for:
contributing to the recording request data by monitoring a plurality of local user requests to record multimedia programs.

21. The reporting server of claim 20, further including instructions for:
receiving user input to define the future period.

22. The reporting server of claim 21, further including instructions for:
presenting selectable predetermined future periods to a user.
